(19) United States
(12) Patent Application Publication
(10) Pub. No.: US 2012/0245958 A1
(43) Pub. Date: Sep. 27, 2012

(54) Case-Centric Medical Records System with Social Networking

(75) Inventors: Donald K. Lawrence, Nashville, TN (US); Rafael R. Fiol, Miami, FL (US); Andrew P. Torres, Marietta, GA (US); David G. Young, Nashville, TN (US)

(73) Assignee: SURGICHART, LLC, Nashville, TN (US)

(21) Appl. No.: 13/429,214

(22) Filed: Mar. 23, 2012

Related U.S. Application Data
(60) Provisional application No. 61/467,710, filed on Mar. 25, 2011.

(51) Int. Cl. G06Q 50/24

(52) U.S. Cl. 705/3

(57) ABSTRACT

A case-centric medical records system with social networking capabilities is disclosed. Using the system, users can build charts that are centered around a single procedure or treatment and include physician notes as well as imagery and video relating to the procedure. Users can also build social networks around their records by identifying colleagues with whom chart data can be shared. Search functions allow the charts to be searched by diagnosis and procedure codes or by other keywords or information. Users can search their networks of colleagues for relevant experience and expertise and can search and review their colleagues' charts to gain insights.

### CROSS-REFERENCE TO RELATED APPLICATIONS

This application claims priority to, and the benefit of, U.S. Provisional Patent Application No. 61/467,710, filed Mar. 25, 2011. The contents of that application are incorporated by reference in their entirety.

### BACKGROUND OF THE INVENTION

1. Field of the Invention

The invention relates generally to medical records management systems, and more particularly to a case-centric medical records system with social networking capabilities.

2. Description of Related Art

For decades, if not centuries, the primary means for a doctor to record information about a patient were pen and paper. The doctor would see his or her patient and write a progress note detailing the patient's history, current symptoms, and planned treatments. A specialist seeing a referred patient would prepare a similar note, and send a copy to the referring physician or surgeon. Surgeons would prepare operative notes describing the exact nature of the procedure that was performed on a patient. In more recent decades, patient notes have sometimes been dictated or typed, but ultimately, all patient records—e.g., progress notes, consult notes, operative notes, test results, and diagnostic imagery—were stored on a physical medium, typically paper, within a patient file or chart.

More recently, electronic medical record systems (EMRs) have come into reasonably widespread use, particularly in large medical groups and hospital settings. With a typical EMR, a physician uses a data entry device to enter medical data directly into an electronic system. For example, a primary care physician may have a computer terminal, a laptop computer, or a tablet computer in his or her exam room, and may use that computer during each patient encounter to enter history, diagnosis and treatment data. With these systems, official medical records are kept in electronic form, and physician/surgeon notes are typically stored alongside or cross-referenced to relevant patient information, like laboratory test results and diagnostic imagery. EMRs can also automate common processes, like making referrals or refilling prescriptions, and can offer practitioners standardized templates for recording patient encounters and procedures.

While they are useful, EMRs have not yet been universally adopted, and many physicians and surgeons lament their shortcomings. Some physicians argue that the interfaces of typical EMRs are not designed for the ways in which they practice, and are cumbersome to use. Others argue that they are more time-consuming than taking paper notes, or that their template-driven approach is impersonal. (See, e.g., Lewis, S., “Brave New EMR,” Ann. Internal Med. Vol. 154, No. 5, pp. 368-369, Mar. 1, 2011.)

Whatever their individual flaws are, EMRs have another limitation: their perspective. Existing EMRs are written to keep records on individual patients, and not necessarily to help physicians, surgeons, and other medical practitioners learn from each other and improve their own performance.

### SUMMARY OF THE INVENTION

One aspect of the invention relates to a case-centric medical records system. In a system according to this aspect of the invention, users or their delegates can create charts that are focused on particular medical procedures or treatments. These charts contain patient data, history, diagnosis, and treatment information, including information on any procedure that may be performed on the patient, and can also contain pre-operative, intra-operative, and post-operative images, video, and audio files. Charts may be searchable by user-specified keywords or by diagnosis and procedure codes.

In another aspect of the invention, the system allows users to designate other users with whom chart information is shared and to form social networks designating which users are permitted to view which charts and which user information. Thus, users who are performing a particular procedure or wish to learn more about it can search charts prepared by other users in their network to find relevant information. Primary care physicians and other medical referrers can also use the system to refer patients with particular problems to other physicians and surgeons who can treat those problems. Additionally, users in the system can search their networks for particular experience and expertise.

Other aspects, features, and advantages of the invention will be set forth in the description that follows.

### BRIEF DESCRIPTION OF THE DRAWING FIGURES

The invention will be described with respect to the following drawing figures, in which like numerals represent like elements throughout the figures, and in which:

FIG. 1 is an illustration of a system according to one embodiment of the invention;

FIG. 2 is an illustration of a main menu system in a client application used in the system of FIG. 1;

FIG. 3 is an illustration of a first, summary page of a medical chart in a client application used in the system of FIG. 1;

FIG. 4 is a map illustrating relationships between users in the system of FIG. 1;

FIG. 5 is an illustration of an exemplary user profile in the system of FIG. 1;

FIG. 6 is an illustration of an exemplary user profile as it may be shown to other users in the system of FIG. 1; and

FIG. 7 is a schematic illustration of a data model for the system of FIG. 1.

### DETAILED DESCRIPTION

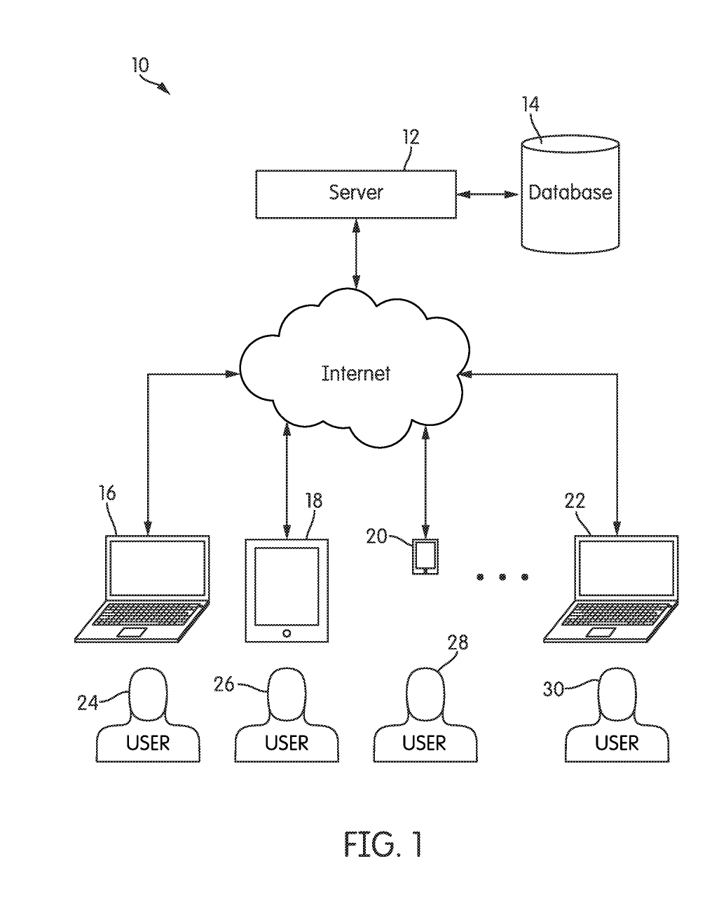

FIG. 1 is an illustration of a system, generally indicated at 10, according to one embodiment of the invention. System 10 is a system for case-centric collection and management of medical data. The term “case centric” refers to a system in which data is collected and organized in a manner that focuses on individual treatments and procedures. More specifically, in a case-centric system such as system 10, information on individual procedures, treatments, and other information relevant to medical practitioners has primacy of place; the system may not be designed to gather and present a comprehensive medical chart for any one patient, and may not contain complete or comprehensive information for any patient. If system 10 does act as a comprehensive medical record for a single patient, the information may be presented from the perspective of the procedures or treatments that were performed. This will be explained below in more detail.

In the following description of system 10 and other embodiments of the invention, the terms “physician,” and “surgeon,” may be used interchangeably, and the term “medical practitioner” should be construed to include physicians, surgeons, and those in allied medical professions. Additionally, the terms “procedure,” “surgery,” and “treatment” may be used interchangeably.

As shown in FIG. 1, system 10 includes a server 12 and a database 14. The server 12 may be, for example, a Web server, implementing Web server software, such as Apache web server software, that allows it to respond to requests from client devices using hypertext transfer protocol (HTTP) and other network communication protocols. In many embodiments, the database 14 may be implemented on the server 12, for example, using a structured query language (SQL) relational database program such as MySQL (Oracle Corporation, Redwood Shores, Calif., U.S.). In other embodiments, the database 14 may be implemented on a separate machine or machines.

It should be understood that although FIG. 1 depicts a single server 12 and a single database 14, in some embodiments of the invention, the server 12 and database 14 may comprise multiple interoperating machines configured to act as one logical machine. Thus, data may be distributed among a number of machines and a number of data repositories that collectively perform the functions ascribed in this description to the server 12 and database 14. In some embodiments, the server 12 may be a stand-alone machine or group of machines that performs only the functions described here; in other embodiments, the server 12 may be shared with other users and organizations and may have a number of other functions. In general, the server 12 and the database 14 may be maintained by one organization for the benefit of a number of organizations, or it may be maintained and used by a single organization.

In system 10, a number of client devices 16, 18, 20, 22 communicate with the server 12 to access the information stored in the database 14. In the illustration of FIG. 1, four client devices 16, 18, 20, 22 are shown, although any number of client devices may be used in system 10. The client devices 16, 18, 20, 22 communicate with the server 12 via the Internet in the view of FIG. 1, but in other embodiments, any type of computing network that can support communication between the client devices 16, 18, 20, 22 and the server 12 may be used, including corporate or private Intranets, virtual private networks (VPNs), and other types of local area and wide area networks (LANs and WANs).

As shown in FIG. 1, in system 10, a variety of different client devices 16, 18, 20, 22 may be used to connect with the server 12 and make use of the information in the database 14. The client devices 16, 18, 20, 22 that may be used include desktop and laptop computers, tablet computers, smart phones, and any other device capable of connecting to the Internet and viewing the information provided by the server 12. The manner in which the client devices 16, 18, 20, 22 do so may vary from device to device, depending on the processing capabilities of each and the nature and type of applications that are available on each device 16, 18, 20, 22.

For example, desktop and laptop computers may access the information on the server 12 using a World Wide Web browser that is directed to a uniform resource locator (URL) on the server 12. The server 12 in that case would provide an interface allowing access to the data on the database 14 using any combination of common World Wide Web markup and scripting languages. For example, the server 12 may provide one or more Web pages in HTML/CSS using JavaScript and other scripting languages to provide the user with an interface to the data in the database 14. Server-side scripting languages, such as PHP, ASP, and JSP, may be used to dynamically create the Web pages that the server 12 provides, and known coding frameworks, such as JBox, may be used in the development and coding of the Web pages to create interface elements.

Thus, in the case of some clients, the interface to the server 12 may use an existing, general-purpose application, like a browser. Other client devices 16, 18, 20, 22 may use applications, or so-called “apps,” that are specific to the client device. For example, if the client devices 18, 20 are the iPad tablet computer and the iPhone smart phone (Apple, Inc., Cupertino, Calif.), then those devices may use iOS apps with interface-specific features to access server 12 and database 14. Applications may be compiled, interpreted, or compiled to a format that can be executed on multiple devices, such as is the case with the Java language.

Regardless of the application that is used on the client device 16, 18, 20, 22, the mode of communication with the server 12 may be the same. For example, an application on a tablet computer or smart phone may make calls to a routine or routines implemented by the operating system that communicate over the World Wide Web using hypertext transfer protocol (HTTP) to retrieve data used by the application. However, communication with the server 12 may be implemented using any suitable protocol, and some applications may communicate with the server 12 using other protocols.

Various encryption schemes may be used to protect data as it is being transmitted between the server 12 and the various clients 16, 18, 20, 22. For example, if communication between the server 12 and clients 16, 18, 20, 22 may use secure sockets layer (SSL) or HTTP Secure (HTTPS) to secure data in transit. Additionally, various schemes may be used to identify users 24, 26, 28, 30 who are accessing the server 12 and the database 14, including username/password authentication and public key cryptography schemes. In many embodiments, in order to protect sensitive medical information, all communication between the server 12 and the clients 16, 18, 20, 22 may be encrypted using HTTPS or another secure transport protocol, or by encrypting the data at the server side before transport.

In system 10, there may be several different interfaces or versions of interfaces, each interface tailored to the type of client 16, 18, 20, 22 being used. For portable clients 18, 20, which may have reduced processing power, limited screen size, and/or limited ability to enter data (e.g., there may be a touch keyboard or a keyboard with small keys), the application and interface may have relatively limited functionality, and some functions may not be available. For example, administrative functions that require substantial data entry may be available only via a Web browser-based interface, presumably to be used with clients 16, 22 that are desktop or laptop computers.

The following description and figures provide examples of the functionality of system 10 from the perspective of an application or browser-based interface running on one of the client devices 16, 18, 20, 22. As was noted briefly above, the features and appearance of the interface may vary from application to application, device to device, and embodiment to embodiment.

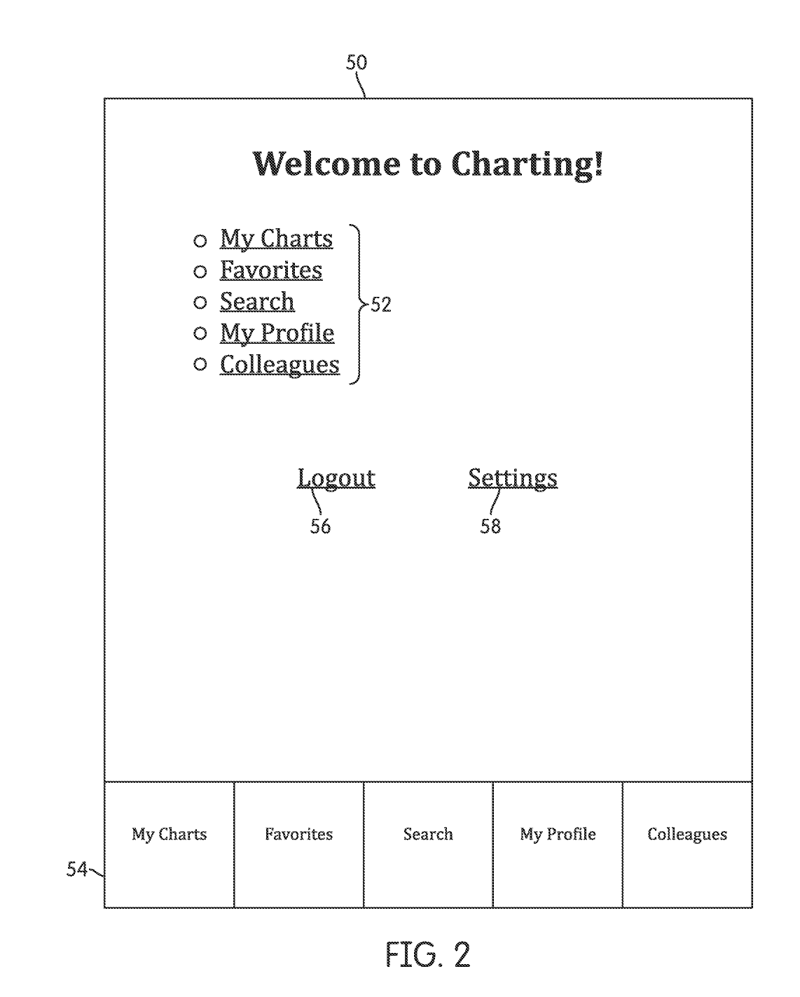

FIG. 2 is an illustration of an exemplary main menu 50 as it might be shown on a smart phone or tablet computer client. The main menu area 52 provides links that allow a user to access the main functions of system 10. As shown in FIG. 2, the main menu area 52 allows the user to access his or her charts, to access favorite charts or cases, to search for charts, procedures, users, and other pieces of data available in system 10, to view and edit his or her profile, and to connect to and share data with colleagues. A navigation menu 54 at the bottom of the main menu allows quick access to each of those functions. In many embodiments, the navigation menu 54 will be present on all screens, allowing the user to switch quickly from one function to another without returning to the main menu 50. The main menu 50 also provides a “logout” link 56 and a settings link 58. The logout link 56 allows a user to log out of system 10.

The settings link 58 takes the user to a page where he or she can enter a variety of settings. The settings that a user may enter or alter include identification of his or her delegates (those empowered to start a new case or edit case information on behalf of a physician or surgeon), hospitals with which the user is affiliated, codes for diagnoses and procedures that the user uses often (e.g. CPT and ICD9 codes), insurance plans that the user accepts, and any other information helpful in the use or administration of system 10. These settings and their uses will be described below in greater detail.

As can be appreciated from the range of functions shown in the main menu 50 of FIG. 2, system 10 has aspects of a medical records system as well as aspects of a social network. Users 24, 26, 28, 30 can create charts that include physician notes, diagnostic imagery, a focused narrative of patient history, and specific information on any surgery or procedure that is performed. Generally, these charts will focus on a single complaint or procedure. Users 24, 26, 28, 30 can also designate “delegates”—other users with rights to create, edit, and delete charts, and can share their charts individually, selectively, or en masse with user-selected colleagues who are also users of system 10.

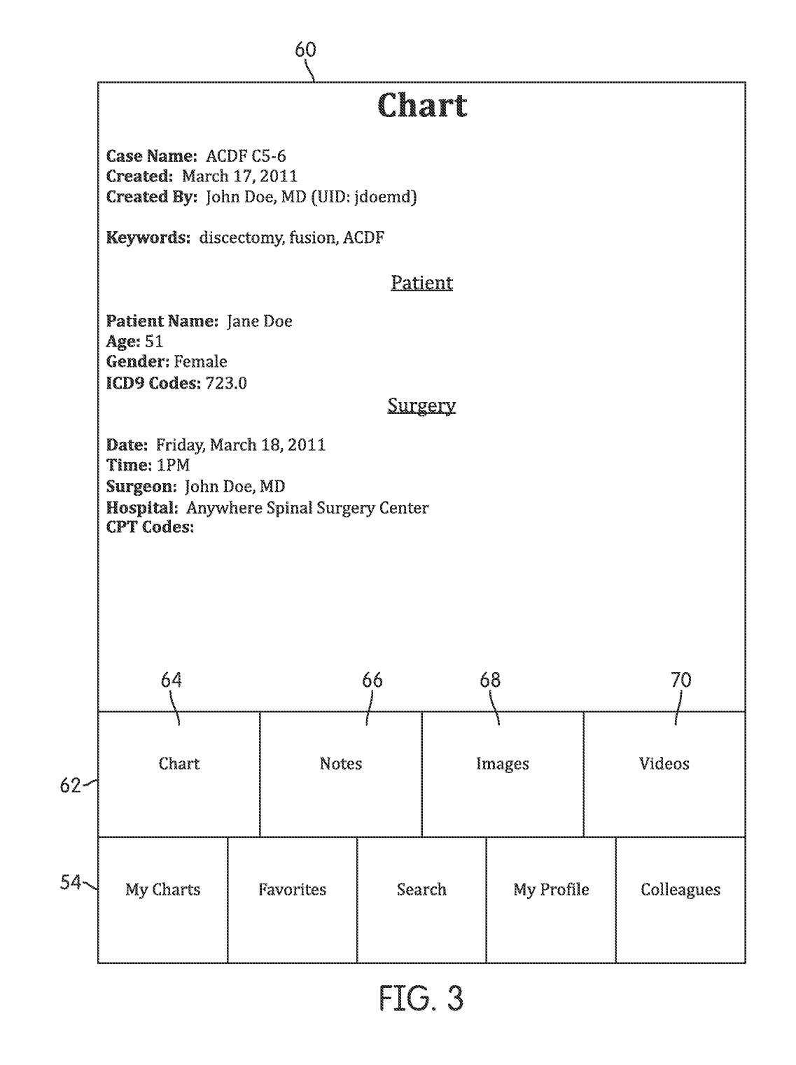

FIG. 3 is an illustration of one page of an exemplary chart 60. The chart page 60 is the first or summary page of the chart. It includes basic information on the case, such as a case name, the date of creation, the name of the creator, and user-selected keywords to facilitate later searching for the chart. In the illustrated case, the patient requires an anterior cervical discectomy and fusion (ACDF) at the level of the 5^{th} and 6^{th} cervical vertebrae, and so the user has titled the case “ACDF C5-6” and used the keywords “discectomy,” “fusion,” and “ACDF” as searchable keywords for the case.

The first page of the chart 60 also provides basic information about the patient, including the patient name, the patient age and gender, and a field for codes indicating the patient's diagnosis or diagnoses (e.g., ICD9 codes). Depending on the embodiment, the database 14 may also store and the chart 60 may present such information as a reference number or medical record number for the case; the patient's ethnicity; the patient's insurance provider; the patient's height and weight; whether or not the patient is employed; whether or not the injury or procedure is covered by workers' compensation or accident insurance; and whether or not the patient has any one of a number of relevant chronic conditions, such as diabetes or osteoporosis. Of course, the first page of the chart 60 need not present all patient information; instead, patient information may be included in other parts of the chart.

A chart menu bar 62 toward the bottom of the chart 60, just above the global menu bar 54, provides access to the main portions of the chart. As shown in FIG. 3, the “chart” link 64 will return the user to the first, summary page of the chart.

The “notes” link 66 takes the user to the notes section, which presents the user with narrative information on the patient's history relative to the current diagnosis and procedure(s); the records of the patient's physical examination(s); relevant prior treatments; records of medical devices or hardware implanted into the patient; the outcome of the procedure(s) that were performed to treat the patient; and postoperative instructions. The notes section may also include intraoperative notes and data, such as the time at which the procedure began, whether or not a blood transfusion was given, any antibiotics or other drugs that were prescribed or administered, any deep vein thrombosis (DVT) or venous thromboembolism prophylaxis, the overall duration of the procedure, and the estimated blood loss.

The “images” link 68 takes the user to the images section of the chart, which contains diagnostic imagery, such as MRI and CT scans, X-ray radiographs, ultrasound images, and any other images that may be associated with the case. In some embodiments, if the client being used to input data is equipped with a camera, the client application may allow direct capture of intra-operative photographs and storage in the images section. The images section may also include functionality that allows images taken with other devices to be imported or uploaded and associated with the chart. Similarly, the “video” link 70 takes the user to a video section, where any videos associated with the case can be stored. In addition to these sections, a chart may also include an audio section to store audio recordings. Audio recordings may include diagnostic audio, such as recordings of auscultations; recordings of patient interviews or examinations; and dictated notes from the physician that are meant for later transcription or permanent storage. Images in the images section and other multimedia files may be grouped according to whether they are pre-operative, intra-operative, or post-operative, or they may be arranged in chronological order either based on their file dates or on the time and date they were uploaded.

In some embodiments, instead of separate links or sections for images, video, and audio, a chart may provide a notes section, and then a link to a single section that stores all “multimedia” files for the chart. Portions of the notes in the notes section may also be hyperlinked to particular images or files in the media sections. For example, if the notes section records that “MRI scan revealed very severe spinal stenosis at C5-6 and narrowing of the canal down to about 5 mm,” the word “MRI” may be linked to the applicable images.

Thus, a single chart can store any medically relevant information on a patient or procedure. However, charts in system 10 are focused on individual diagnoses and the procedures that are used to correct them, rather than attempting to capture a complete history and overall picture of a patient's health and wellness.

Certain features may be added in system 10 to assist physicians in creating charts for procedures that they perform often. For example, templates may be used in creating charts to provide them with standardized titles, automatically insert diagnosis and procedure codes, and automatically insert hospital and other information that does not vary from patient to patient. A user may define a number of procedures that they perform often, and may be permitted to select one of those procedures from a list when creating a new chart. Macros may also be used to insert specific language in written narratives.

The information in a chart helps the physician to organize case records for his or her own benefit. As shown in FIGS. 2 and 3, a search function may allow the physician to search his or her charts based on any piece of information in the chart, including patient name, diagnostic or procedure codes, keywords, etc. This can help individual physicians to locate records for review, and may also be of assistance in treatment planning for new patients. In some embodiments, if a user is opening a new chart for a new patient and enters a diagnosis or procedure code or a keyword that has already been used, the client application may ask the user whether he or she wishes to retrieve and review other cases with those same diagnosis or procedure codes or keywords. Additionally, although system 10 is a stand-alone system in the illustrated embodiment, in other embodiments, middleware or other means could be used to transfer the information in system 10 into an existing hospital- or practice-wide medical records system or to interface system 10 with such a system.

In some embodiments, the server 12 may provide an Internet-based feed or may allow certain information from charts to be exported. For example, the server 12 could allow the export of surgical times and dates in iCalendar format, so that if a user enters the date and time of a surgery into system 10, that information can be exported to his or her personal calendar or schedule. Alternatively, the server 12 may provide an Internet-based feed of all surgical dates and times for each user. Additionally, as will be described below in more detail, charts 60 may be e-mailed to users and non-users of system 10 for study, discussion, and informational purposes.

Thus, the chart 60 provides each individual user 24, 26, 28, 30 with an ability to record medical information in a case-centric way and access it for later reference or study. However, a particular advantage of system 10 is that information may be shared among multiple users.

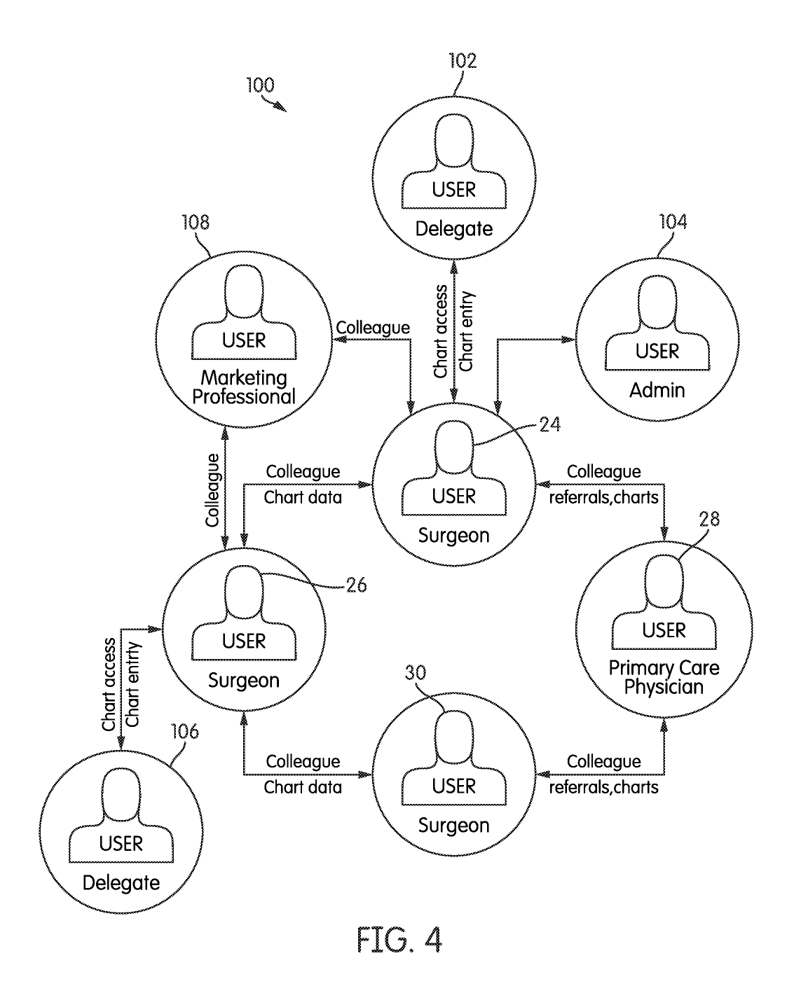

FIG. 4 is a conceptual map, generally indicated at 100, of the relationships between users and their data using system 10. In the map 100, user 24 is a surgeon with access to system 10. Thus, the surgeon 24 is able to use system 10 to create charts, enter notes, upload audio, images, and video files and associate them with charts, and perform all other actions allowed to users in system 10. In most cases, the surgeon 24 will also have a variety of people with whom he or she works, including medical assistants, nurses, and other staff members, and vendors, like medical device manufacturer representatives. Any of those people may act as a delegate 102 for the surgeon 24.

In system 10, delegates are individuals who are selected and designated by a primary user, such as surgeon 24, and have rights to create, access, edit, and delete charts on behalf of that primary user. For example, in map 100, delegate 102 has rights to create, access, edit, and delete charts on behalf of surgeon 24. Of course, a delegate need not have all of those rights; some delegates may have more rights than others. For example, a medical device manufacturer's representative may be delegated the rights to enter certain information in a chart, but may not have rights to create new charts or delete them. The primary user in question may have the ability to designate the rights of his or her delegates, or that ability may be possessed by an administrator 104, as will be described below.

As shown, the surgeon 24 also has an administrator 104 associated with it. The administrator 104 may be a professional associated with the surgeon 24 or his or her practice, like a hospital administrator or an information technology professional. Administrators may have the rights to perform certain meta-tasks, such as creating new user accounts in system 10. Generally speaking, as will be described below in more detail, each user 24, 26, 28, 30 will sign up for his or her own account. However, in cases where a user 24, 26, 28, 30 does not wish to sign up for his or her own account, or does not have time to do so, an administrator, such as administrator 104, may create an account on behalf of a user, such as surgeon 24. In some embodiments, administrators may also have the ability to create multiple user accounts in batch fashion by importing or converting user information from existing databases, and may be able to specifically designate which users have access to which information. However, administrators need not necessarily be in supervisory or administrative roles relative to the user; instead, in some embodiments, a medical device manufacturer's representative may act as an administrator, rather than a delegate, so that he or she can create accounts for new users.

As shown in the map 100 of FIG. 4, surgeon 24 has two colleagues, user 28 (a primary care physician) and user 26 (another surgeon). “Colleagues,” in this context, are users with whom a specific user has decided to share charts and other data in system 10. Any two colleagues may have any kind of “real-life” relationship—they may work in the same practice or hospital, or they may work in different practices or hospitals. They may be in the same medical specialty or different medical specialties. They may have a patient-referring relationship with respect to one another, or one user may be a specialist or allied professional who provides services to the patients of another user.

When two users, for example, the two surgeons 24, 26 of map 100, are linked as colleagues, generally speaking, they are able to see each other's charts if those charts are not marked private. Of course, in some embodiments or situations, even if a chart is made accessible to other users, some fields of information in the chart, such as the patient's name and other personally identifying information, may be secured so that they are not shared with colleagues generally, or may be shared only with colleagues who work in the same organization, are treating or participating in the treatment of the patient, or would normally have access to the information for other reasons. Privacy and information sharing settings may be determined, at least in part, based on applicable laws and regulations regarding dissemination of medical information.

User 26, also a surgeon, has as colleagues user 24 and user 30, yet another surgeon. User 26 also has a delegate 106 to manage his or her charts. Thus, user 26 can see charts from user 24 and user 30. However, user 30 is not a colleague of user 24 in the scheme of map 100; therefore, user 30 would not be able to see charts from user 24 in this scheme. In other embodiments or other situations, second- or third-degree colleagues (i.e., colleagues of colleagues or colleagues of colleagues of colleagues) may be able to see chart data, or at least some portions of it; one advantage of system 10 is that these privacy and information exchange rules can be set on an ad hoc basis.

User 28 in map 100 is a primary care physician. In this scheme, a primary care physician, such as user 28, may create a chart with patient history notes and whatever diagnostic testing has been done and refer that patient, by electronically forwarding the chart, to either of the surgeons 24, 26 in his or her network. In addition to forwarding cases, any user 24, 26, 28, 30 may search the network for users with particular expertise. As those of skill in the art will understand,

Users 24, 26, 28, 30 may also use charts created by their colleagues as learning tools. For example, when a surgeon searches for charts with procedures similar to one that he or she may need to perform, he or she may also search charts created by his or her network of colleagues for useful information. Users 24, 26, 28, 30 may also create public and private groups in which to circulate and discuss charts.

The above description focuses on the communication of charts and chart data between medical and allied professionals. However, the information collected in system 10 may be used for a variety of other purposes. Professionals other than physicians and allied professionals may use system 10, including marketing professionals, pharmaceutical company employees and executives, medical device company executives and employees, researchers, academics, and others with an interest or role in medicine. For example, FIG. 4 also includes a user 108, a marketing professional 108. The marketing professional 108 is colleagues with two surgeons, users 24 and 26, and may, for example, be employed by a hospital or practice group with which the two surgeons 24, 26 are affiliated.

As a colleague of the two surgeons 24, 26, the marketing professional 108 can observe which procedures the surgeons 24, 26 are performing, how many procedures of each type the surgeons 24, 26 have performed, which devices were used and/or implanted during the procedures, and any other information that is recorded in the charts. More generally, the aggregate information stored in system 10 provides insights into how the users of the system practice medicine, and may be used for a variety of purposes, including marketing, sales, and research. An individual professional, such as marketing professional 108, may have access to some or all of this data. However, in some embodiments, information from system 10 may be redacted or anonymized as necessary and used to derive statistics or indications of practice trends, patient outcomes, and other related matters. That information, in turn, may be provided or sold to interested parties.

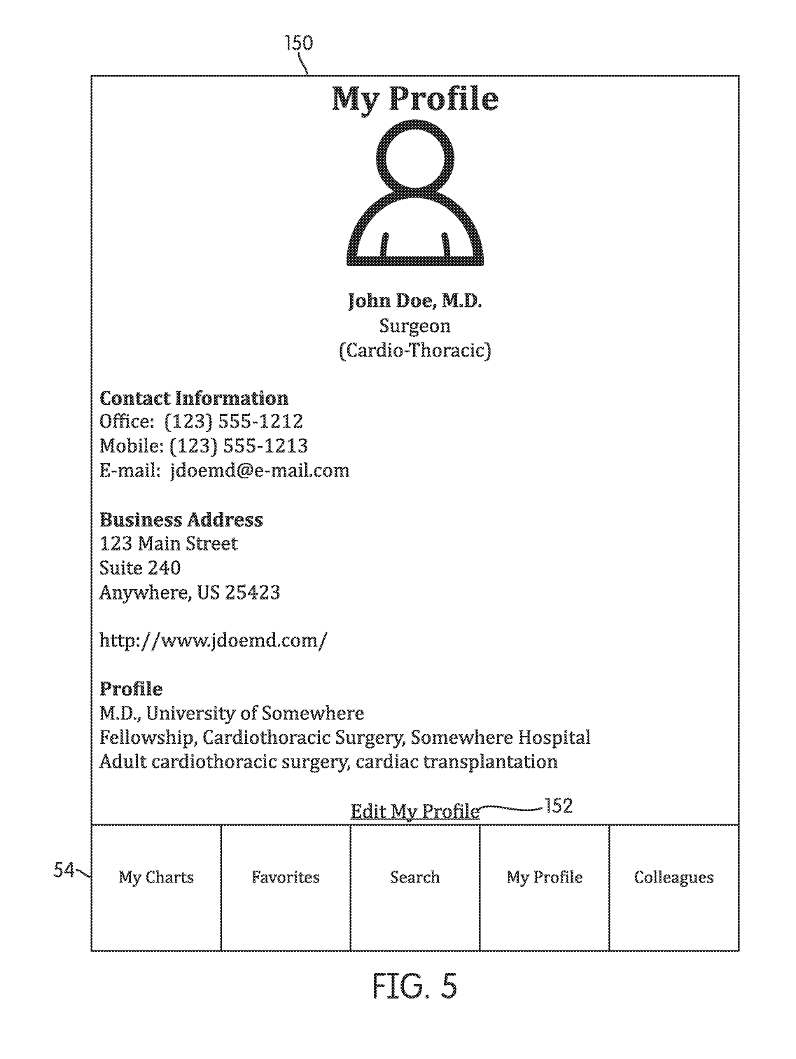

FIG. 5 is an illustration of a user profile page 150. The profile page 150 contains an identification of the user, his or her role and/or specialty (in the case of FIG. 5, the user is a cardiothoracic surgeon), and contact information for the user, including telephone numbers, an e-mail address, and a Web page address. The profile page 150 may also contain a profile or summary of the user's professional qualifications, and optionally, a listing of the procedures or services that the user provides. In some embodiments, users may also provide a longer-form narrative of their interests and expertise.

Typically, each user 24, 26, 28, 30 in system 10 would have a profile page like profile page 150. The information on the page would generally be gathered by asking the user to answer a series of questions when he or she opens an account in system 10. However, the system 10 may only require basic contact and specialty information to open an account; other information may be supplied by the users 24, 26, 28, 30 at their convenience. A link 152 may be provided to allow users to edit their profiles. A user 24, 26, 28, 30 may be able to specify his or her delegates by editing his or her profile page. Alternately, a separate link may allow a user to manage his or her delegates, contacts, and other connections in system 10.

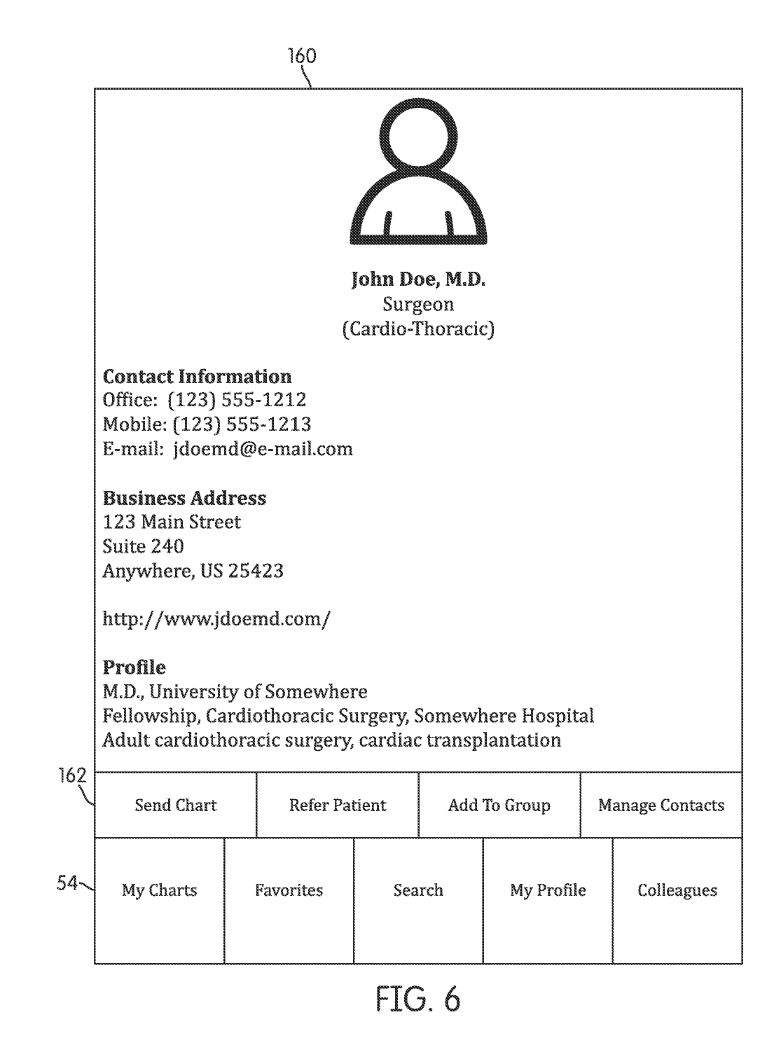

When viewed by other users 24, 26, 28, 30, a user's profile may have different or additional information, and may allow a range of functions. FIG. 6 illustrates a user profile page 160 as it might be viewed by other users. The user profile page 160 of the illustrated embodiment includes the same basic information shown in the user profile page 150, although in some embodiments, some information in a user's profile may be protected and not shown to other users, or to users who are not colleagues.

The profile page 160 allows the viewing user to interact with the profiled user in a number of ways. As an example, the profile page 160 includes a menu bar 162 that allows the viewing user to send a chart or message to the profiled user, refer a patient to the profiled user, add the profiled user to a group for discussion and circulation of charts, and manage his or her contacts. In system 10, messages and charts may be “sent” between users by way of e-mail messages that contain a link or links to the chart in question along with whatever optional note or message the sending user may wish to include. Messages in system 10 may be sent via an interface to a general e-mail system, by a message system internal to system 10, or by both general purpose and system-specific messaging means.

Depending on the embodiment, messages between users may be used for a variety of other purposes. For example, in some embodiments, system 10 may allow a user's delegates and, optionally, his or her colleagues to be notified whenever the user posts a new chart. Similarly, if a user forms a group of users, all of the users in the group may be notified when a chart is posted to the group for discussion.

In the illustrated embodiment, a user 24, 26, 28, 30 may view another user's profile page by selecting “colleagues” from the menu bar 54 and then selecting a colleague's name from a list, which may be organized alphabetically, by specialty, or by some other criterion. As was explained above with respect to map 100 of FIG. 4, lists of colleagues are individual to each user and are generated dynamically by the server 12 using sets of tables in a relational database system stored in the database 14.

Each user's colleagues list is typically unique to that user because each user typically takes responsibility for inviting his or her real-life colleagues to become users of system 10, and for finding real-life colleagues who are already users of system 10 and connecting with them by making them colleagues on system 10. For example, a user may enter a real-life colleague's e-mail address in order to determine whether or not that real-life colleague is a user of system 10. If not, the user may direct system 10 to send an appropriate e-mail in the user's name introducing the system to that real-life colleague and inviting them to join.

Although usage of system 10 may propagate user-to-user and be driven by the users, that is not the only way in which new users may be added. For example, a device or drug manufacturer's representative or another professional may act as an administrator to create an account for a physician or another professional. In other embodiments, if all physicians affiliated with a hospital or other institution are to be users of system 10, accounts may be created automatically based on an existing user database or databases.

While the above description may focus on user-to-user information exchange within system 10, individuals who are not necessarily users of system 10 may benefit from it and/or access its information. For example, a user may choose to e-mail a link to a chart stored in system 10 to a non-user along with an invitation to join system 10.

In some embodiments, an individual may not need to become a user of system 10 in order to receive or view chart information or other information stored in system 10. For example, a surgeon 24, 26 may allow a patient to view his or her own chart information by e-mailing them a URL to a static Web page that presents the information in a non-editable form. Similarly, users 24, 26, 28, 30 of system 10 may have static, publicly-viewable versions of their user profiles 150 that are posted on the World Wide Web. Publicly accessible versions of information from system 10 may not include information on the chart that is designated private or that is protected by law or regulation.

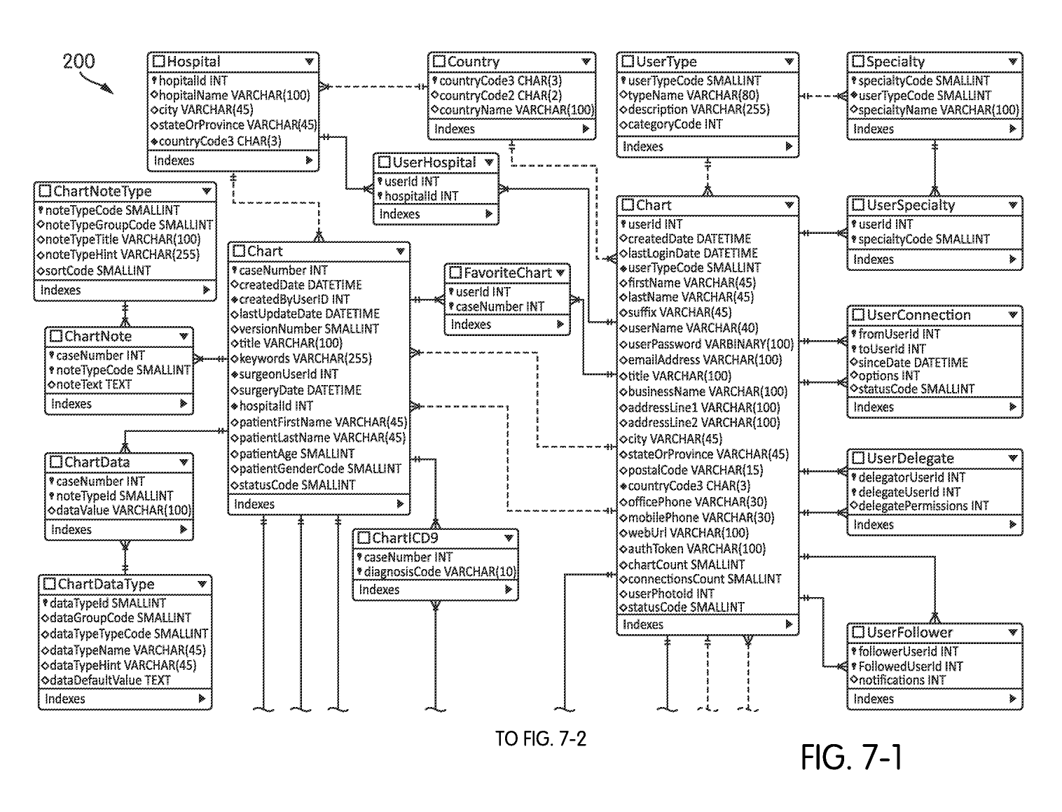

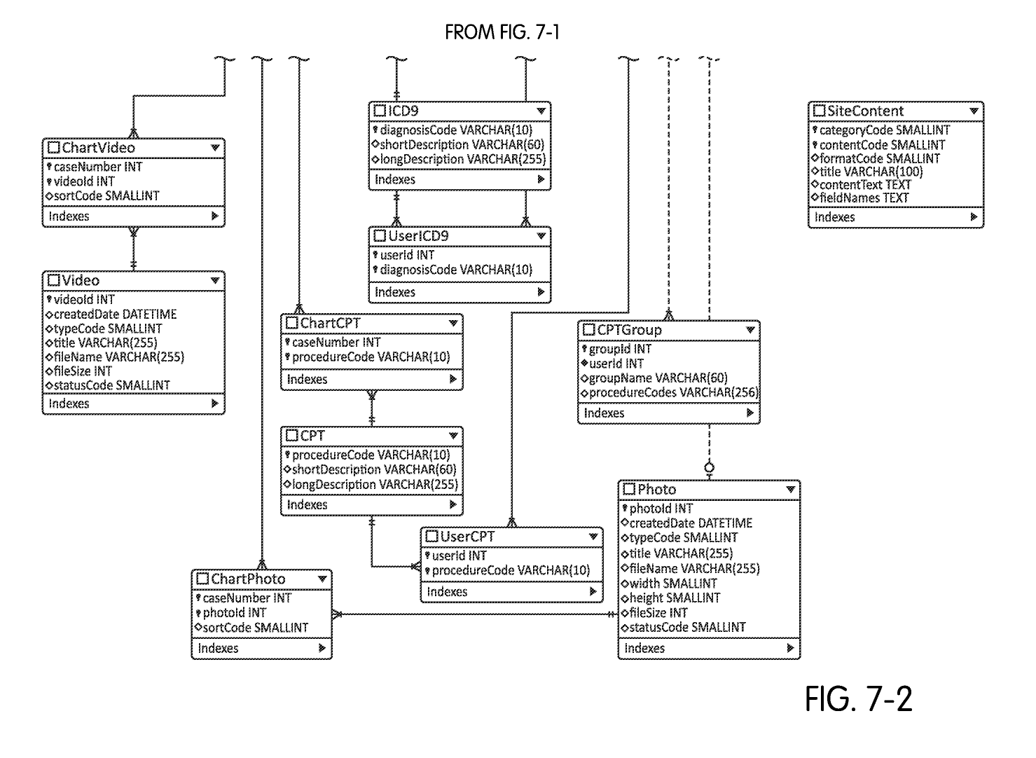

As was noted above, system 10 may be implemented, in part, using a relational database 14 or system of databases. FIG. 7 is an illustration of a data model map 200 of an exemplary set of tables that may be created in order to store the data for system 10 in the database 14. The data model map 200 lists each table used by system 10, as well as the fields and data types for each field. As shown in the data model map 200, the two tables with the most information are the tables “User” and “Chart,” which store information on the users and the charts, respectively. A number of ancillary tables with fewer fields store information on hospitals, medical specialties, countries, ICD9 and CPT codes, delegates, connections between users, and information about photographs, video, and notes that are associated with particular charts. Each table has at least one field that relates it to other tables. For example, the “User” table has an integer field “userId,” which contains a unique numerical identifier for each user. The “Chart” table has two fields that allow it to be related to the users who created it and are performing the procedure described in it, “createdByUserId” and “surgeonUserId,” which both store integers referencing particular users. As those of skill in the art will understand, the map 200 and data model reflected in it are but one example of the kinds of data models that may be used in embodiments of the inventions. In other embodiments, other tables, fields, and data types may be used.

In some embodiments, the client devices 16, 18, 20, 22 may be provided with their own ad hoc databases. These ad hoc databases may include all of the tables present in the larger data model of system 10, or only a subset of the tables. Such databases on the client devices 16, 18, 20, 22 may be used for a variety of purposes. For example, in some embodiments, users 24, 26, 28, 30 may be permitted to download charts for review when they are not connected to the server 12 via a computer network. In other embodiments, databases on the client devices 16, 18, 20, 22 may be used essentially as buffers to pre-load information from the server 12 while the user is performing other tasks.

While the invention has been described with respect to certain embodiments, the description is intended to be exemplary, rather than limiting. Modifications and changes may be made within the scope of the invention, which is defined by the appended claims.

What is claimed is:

1. A method for creating, accessing, and sharing medical data, comprising:
allowing a user to create a medical record, centered around a specific diagnosis and treatment, the medical record being adapted to associate patient information, treatment information, imagery, and video; and
allowing the user to create a social network by designating other users with whom the medical record is to be shared, at least in part.

2. The method of claim 1, wherein a plurality of users create a plurality of the medical records.

3. The method of claim 2, further comprising allowing the user to search a portion of the plurality of medical records to which the user has access for information.

4. The method of claim 2, further comprising allowing the plurality of users to create and store profiles that are viewable by respective designated other users.

5. The method of claim 2, further comprising providing a first, Web-based interface for accessing the plurality of medical records.

6. The method of claim 5, further comprising providing a second interface for accessing the plurality of medical records that is specific to a client device.

7. A system for creating, accessing, and sharing medical data, comprising:
a database that allows medical charts related to particular diagnoses and treatments to be created, stored, and associated with particular users, the database system also allowing users to be selectively associated with other users to form social networks in which associated users are permitted selective access to the medical charts in their social networks; and
a server in communication with the database and with a computer network, the server providing access to the information in the database.

8. The system of claim 7, wherein the server provides a first interface over the computer network.

9. The system of claim 8, wherein the first interface is a World Wide Web-based interface.

10. The system of claim 7, further comprising a second interface specific to a client device that is adapted to communicate with the server over the communications network.

11. The system of claim 7, wherein the server is adapted to allow selected medical charts to be downloaded to a client device for offline viewing independent of the computer network.

12. A set of instructions on a machine-readable medium interoperable with a machine to perform tasks comprising:
communicating with a server and a database system over a computer network to create medical records, each one centered around a specific diagnosis and treatment, that are adapted to store and associate patient information, treatment information, imagery, and video; and
selectively associating pluralities of users of the server and database system with one another, such that associated users are provided shared access to the medical records.

13. The set of instructions of claim 12, wherein each of the users of the server and database system has a user account with a set of identifying information.

14. The set of instructions of claim 13, wherein the set of instructions allows the users to associate themselves into the pluralities of users.

15. The set of instructions of claim 13, wherein each of the users is permitted to designate individuals who have permission to perform one or more of creating, modifying, and deleting the medical records on behalf of the user.

16. The set of instructions of claim 12, wherein the tasks further comprise searching the server and database system for a specific one of the medical records.
